(19) United States
(12) Patent Application Publication
(10) Pub. No.: US 2026/0159654 A1
(43) Pub. Date: Jun. 11, 2026

(54) FIBER REINFORCED THERMOPLASTIC POLYMER COMPOSITION

(71) Applicant: SABIC GLOBAL TECHNOLOGIES B.V., Bergen op Zoom (NL)

(72) Inventors: Robert Maria Martin DONNERS, Brunssum (NL); Gerard Jan Eduard BIEMOND, Brunssum (NL); Gert BOVEN, Steenbergen (NL)

(21) Appl. No.: 19/125,845

(22) PCT Filed: Oct. 30, 2023
(86) PCT No.: PCT/EP2023/080227

§ 371 Date: Apr. 30, 2025

(30) Foreign Application Priority Data
Oct. 31, 2022 (EP) 22204760.7
Oct. 31, 2022 (EP) 22204761.5
Dec. 20, 2022 (EP) 22215133.4

(51) Int. Cl. C08J 5/08; C03C 25/30

(52) U.S. Cl. CPC C08J 5/08; C03C 25/30; C08J 2323/12

(57) ABSTRACT

A fiber reinforced thermoplastic polymer composition including a sheathed continuous multifilament strand including a core that extends in the longitudinal direction and a polymer sheath which intimately surrounds said core, wherein the core includes at least one continuous multifilament strand including a plurality of coated filaments which are bundled, wherein each of the coated filaments is a coated filament including an inorganic filament and a first polymer composition including a first thermoplastic polymer, preferably wherein the inorganic filament is a glass filament, wherein the first polymer composition is in direct contact with the filament, wherein the polymer sheath consists of a second thermoplastic polymer composition including a second thermoplastic polymer.

### CROSS REFERENCE TO RELATED APPLICATIONS

This application is a National Stage application of PCT/EP2023/080227, filed Oct. 30, 2023, which claims the benefit of European Application No. 22204760.7, filed Oct. 31, 2022; European Application No. 22204761.5, filed Oct. 31, 2022; and European Application No. 22215133.4, filed Dec. 20, 2022; all of which are incorporated by reference in their entireties herein.

### BACKGROUND

The present invention relates to a fiber reinforced thermoplastic polymer composition and a process for producing such composition. The present invention further relates to a molded article made from such composition.

A glass fiber-reinforced thermoplastic polymer composition can be made by a process comprising subsequent steps of unwinding from a package of a continuous glass multifilament strand and applying a sheath of polypropylene around said multifilament strand to form a sheathed continuous multifilament strand.

Such process is known from International application WO2009/080281. This published patent application discloses a process for producing a long glass fiber-reinforced thermoplastic polymer composition, which comprises the subsequent steps of i) unwinding from a package of at least one continuous glass multifilament strand, ii) applying an impregnating agent to said at least one continuous glass multifilament strand to form an impregnated continuous multifilament strand, and iii) applying a sheath of thermoplastic polymer around the impregnated continuous multifilament strand to form a sheathed continuous multifilament strand.

WO2014/053590, WO2016/062569 and WO2015/032699 disclose pellets of a fiber reinforced polymer composition comprising a core and a thermoplastic polymer sheath surrounding said core, wherein the core comprises glass fibers extending in a longitudinal direction of the pellets and an impregnating agent.

It is desirable that a molded article made from a fiber reinforced thermoplastic polymer composition has good mechanical properties such as flexural and tensile properties. It is also desirable that the article emits less volatile compounds. Good visual appearance is also desirable such as an appearance with less white spots. White spots may occur due to an insufficient dispersion of the fibers in the article. Good adhesion to glue and foam is also desirable.

It is an objective of the present invention to provide a fiber reinforced thermoplastic polymer composition in which the above-mentioned and/or other needs are met.

### SUMMARY

Accordingly, the present invention provides a fiber reinforced thermoplastic polymer composition comprising a sheathed continuous multifilament strand comprising a core that extends in the longitudinal direction and a polymer sheath which intimately surrounds said core,
wherein the core comprises at least one continuous multifilament strand comprising a plurality of coated filaments which are bundled,
wherein each of the coated filaments is a coated filament comprising an inorganic filament and a first polymer composition comprising a first thermoplastic polymer, preferably wherein the inorganic filament is a glass filament,
wherein the first polymer composition is in direct contact with the filament,
wherein the polymer sheath consists of a second thermoplastic polymer composition comprising a second thermoplastic polymer.

### DETAILED DESCRIPTION

The invention further provides a process for the production of the fiber reinforced thermoplastic polymer composition according to the invention, wherein the sheathed continuous multifilament strand is prepared by the sequential steps of
a) unwinding from a package of the at least one continuous multifilament strand,
b) optionally applying an impregnating agent to the at least one continuous multifilament strand and
c) applying the sheath of the thermoplastic polymer composition around the (impregnated) continuous multifilament strand to form the sheathed continuous multifilament strand.

Details relevant to steps a)-c) are described in WO2009/080281A1, which document is hereby incorporated by reference.

The process for the production of the fiber reinforced thermoplastic polymer composition according to the invention may further comprise the step of
d) cutting the sheathed continuous multifilament strand into pellets.

It was surprisingly found that a molded article made using the fiber reinforced thermoplastic polymer composition according to the invention has good mechanical properties. Such article may emit less volatile compounds. Such article may further have good visual appearance and good adhesion to glue and foam.

### Sheathed Continuous Multifilament Strand

The fiber reinforced thermoplastic polymer composition according to the invention, which may be in the form of pellets, comprises or consists of the sheathed continuous multifilament strand. The sheathed continuous multifilament strand comprises or consists of a core and a polymer sheath. The core has a generally cylindrical shape and comprises at least one continuous multifilament strand. The core may consist of the at least one continuous multifilament strand. The core may consist of at least one impregnated continuous multifilament strand comprising the at least one continuous multifilament strand impregnated with an impregnating agent. The at least one continuous multifilament strand comprises or consists of a plurality of coated filaments which are bundled. The core is intimately surrounded around its circumference by a polymer sheath having a generally tubular shape and consisting of a second thermoplastic polymer composition. The inorganic filaments have a length substantially equal to the axial length of the pellet.

The core does not substantially contain the material of the sheath. The sheath is substantially free of the inorganic filaments. Such a pellet structure is obtainable by a wire-coating process such as for example disclosed in WO 2009/080281 and is distinct from the pellet structure that is obtained via the typical pultrusion type of processes such as disclosed in U.S. Pat. No. 6,291,064.

Preferably, the polymer sheath is substantially free of the inorganic filaments, meaning it comprises less than 2 wt % of the inorganic filaments based on the total weight of the polymer sheath.

Preferably, the radius of the core is between 800 and 4000 micrometer and/or the thickness of the polymer sheath is between 500 and 1500 micrometer.

In some embodiments, the core comprises between 3 and 35% of the cross section area of the pellet and the sheath comprises between 65 and 97% of the cross section area of the pellet. In some embodiments, the core comprises between 35 and 60% of the cross section area of the pellet and the sheath comprises between 40 and 65% of the cross section area of the pellet.

Preferably, the amount of the (impregnated) continuous multifilament strand is 10 to 80 wt %, for example 10 to 50 wt % (for example 25 to 45 wt %) or 50 to 80 wt/a (for example 60 to 75 wt %), with respect to the sheathed continuous multifilament strand. Preferably, the amount of the second thermoplastic composition is 20 to 90 wt %, for example 20 to 50 wt % (for example 25 to 40 wt %) or 50 to 90 wt % (for example 55 to 75 wt %), with respect to the sheathed continuous multifilament strand. Preferably, the total amount of the (impregnated) continuous multifilament strand and the second thermoplastic composition is 100 wt % with respect to the sheathed continuous multifilament strand.

### Polymer Sheath

The sheath intimately surrounds the core. The term intimately surrounding as used herein is to be understood as meaning that the polymer sheath substantially entirely contacts the core. Said in another way the sheath is applied in such a manner onto the core that there is no deliberate gap between an inner surface of the sheath and the core containing the impregnated continuous multifilament strands. A skilled person will nevertheless understand that a certain small gap between the polymer sheath and the core may be formed as a result of process variations.

The polymer sheath consists of a second thermoplastic polymer composition.

### Thermoplastic Polymer Composition of Polymer Sheath

The second thermoplastic polymer composition comprises a second thermoplastic polymer. Preferably, the second thermoplastic polymer composition consists of the second thermoplastic polymer and any additives described below.

### Thermoplastic Polymer in Thermoplastic Polymer Composition of Polymer Sheath

The amount of the second thermoplastic polymer with respect to the second thermoplastic polymer composition may be at least 50 wt %, for example 50 to 99.9 wt %, 75 to 99.9 wt % or 95 to 99 wt %.

Suitable examples of second thermoplastic polymers include but are not limited to polyamide, such as polyamide 6, polyamide, 66 or polyamide 46; polyolefins, for example polypropylenes and polyethylenes; polyesters, such as polyethylene terephthalate, polybutylene terephthalate; polycarbonates; polyphenylene sulphide; polyurethanes and mixtures thereof.

The second thermoplastic polymer is preferably a polyolefin, more preferably a polyolefin chosen from the group of polypropylenes or elastomers of ethylene and α-olefin comonomer having 4 to 8 carbon atoms, and any mixtures thereof.

In one embodiment, preferably the second thermoplastic polymer composition comprises at least 80 wt % of the second thermoplastic polymer, for example at least 90 wt %, at least 93 wt %, at least 95 wt %, at least 97 wt % at least 98 wt % or at least 99 wt % of the second thermoplastic polymer based on the second thermoplastic polymer composition. In a special embodiment, the second thermoplastic polymer composition consists of the second thermoplastic polymer. In another embodiment, the second thermoplastic polymer composition comprises at least 60 wt %, for example at least 70 wt %, for example at least 75 wt % and/or at most 99 wt %, for example at most 95 wt %, for example at most 90 wt % of the second thermoplastic polymer.

Preferably, the second thermoplastic polymer has a melt flow index in the range from 20 to 150 dg/min, for example in the range from 30 to 140 dg/min as measured according to ISO1133-1:2011 (2.16 kg/230° C.). Preferably, the second thermoplastic polymer has a melt flow index in the range from 50 to 130 dg/min as measured according to ISO1133-1:2011 (2.16 kg/230° C.).

The polypropylene may for example be a propylene homopolymer or a random propylene copolymer or a heterophasic propylene copolymer.

A propylene homopolymer can be obtained by polymerizing propylene under suitable polymerization conditions. A propylene copolymer can be obtained by copolymerizing propylene and one or more other α-olefins, preferably ethylene, under suitable polymerization conditions. The preparation of propylene homopolymers and copolymers is, for example, described in Moore, E. P. (1996) Polypropylene Handbook. Polymerization, Characterization, Properties, Processing, Applications, Hanser Publishers: New York.

The random propylene copolymer may comprise as the comonomer ethylene or an α-olefin chosen from the group of α-olefins having 4 to 10 C-atoms, preferably ethylene, 1-butene, 1-hexene or any mixtures thereof. The amount of the comonomer is preferably at most 10 wt % based on the random propylene copolymer, for example in the range from 2-7 wt % based on the random propylene copolymer.

Polypropylenes can be made by any known polymerization technique as well as with any known polymerization catalyst system. Regarding the techniques, reference can be given to slurry, solution or gas phase polymerizations; regarding the catalyst system reference can be given to Ziegler-Natta, metallocene or single-site catalyst systems. All are, in themselves, known in the art.

Heterophasic propylene copolymers are generally prepared in one or more reactors, by polymerization of propylene in the presence of a catalyst and subsequent polymerization of an ethylene-α-olefin mixture. The resulting polymeric materials are heterophasic, but the specific morphology usually depends on the preparation method and monomer ratios used.

The heterophasic propylene copolymers can be produced using any conventional technique known to the skilled person, for example multistage process polymerization, such as bulk polymerization, gas phase polymerization, slurry polymerization, solution polymerization or any combinations thereof. Any conventional catalyst systems, for example, Ziegler-Natta or metallocene may be used. Such techniques and catalysts are described, for example, in WO06/010414; Polypropylene and other Polyolefins, by Ser van der Ven, Studies in Polymer Science 7, Elsevier 1990; WO06/010414, U.S. Pat. Nos. 4,399,054 and 4,472,524.

Preferably, the heterophasic propylene copolymer is made using Ziegler-Natta catalyst.

The heterophasic propylene copolymer may be prepared by a process comprising
polymerizing propylene and optionally ethylene and/or α-olefin in the presence of a catalyst system to obtain the propylene-based matrix and
subsequently polymerizing ethylene and α-olefin in the propylene-based matrix in the presence of a catalyst system to obtain the dispersed ethylene-α olefin copolymer.

These steps are preferably performed in different reactors. The catalyst systems for the first step and for the second step may be different or same.

The heterophasic propylene copolymer comprises a propylene-based matrix and a dispersed ethylene-α-olefin copolymer. The propylene-based matrix typically forms the continuous phase in the heterophasic propylene copolymer. The amounts of the propylene-based matrix and the dispersed ethylene-α-olefin copolymer may be determined by ¹³C-NMR, as well known in the art.

The propylene-based matrix consists of a propylene homopolymer and/or a propylene copolymer consisting of at least 70 wt % of propylene monomer units and at most 30 wt % of comonomer units selected from ethylene monomer units and α-olefin monomer units having 4 to 10 carbon atoms, for example consisting of at least 80 wt % of propylene monomer units and at most 20 wt % of the comonomer units, at least 90 wt % of propylene monomer units and at most 10 wt % of the comonomer units or at least 95 wt % of propylene monomer units and at most 5 wt % of the comonomer units, based on the total weight of the propylene-based matrix.

Preferably, the comonomer in the propylene copolymer of the propylene-based matrix is selected from the group of ethylene, 1-butene, 1-pentene, 4-methyl-1-pentene, 1-hexen, 1-heptene and 1-octene, and is preferably ethylene.

Preferably, the propylene-based matrix consists of a propylene homopolymer.

The melt flow index (MFI) of the propylene-based matrix (before the heterophasic propylene copolymer is mixed into the composition of the invention), MFI_{PP}, may be for example at least 0.1 dg/min, at least 0.2 dg/min, at least 0.3 dg/min, at least 0.5 dg/min, at least 1 dg/min, at least 1.5 dg/min, and/or for example at most 50 dg/min, at most 40 dg/min, at most 30 dg/min, at most 25 dg/min, at most 20 dg/min, measured according to ISO1133 (2.16 kg/230° C.). The MFI_{PP} may be in the range of for example 0.1 to 50 dg/min, for example from 0.2 to 40 dg/min, for example 0.3 to 30 dg/min, for example 0.5 to 25 dg/min, for example from 1 to 20 dg/min, for example from 1.5 to 10 dg/min, measured according to ISO1133 (2.16 kg/230° C.).

The propylene-based matrix may e.g. be present in an amount of 50 to 95 wt %. Preferably, the propylene-based matrix is present in an amount of 60 to 85 wt %, for example at least 65 wt % or at least 70 wt % and/or at most 78 wt %, based on the total heterophasic propylene copolymer.

The propylene-based matrix is preferably semi-crystalline, that is it is not 100% amorphous, nor is it 100% crystalline. For example, the propylene-based matrix is at least 40% crystalline, for example at least 50%, for example at least 60% crystalline and/or for example at most 80% crystalline, for example at most 70% crystalline. For example, the propylene-based matrix has a crystallinity of 60 to 70%. For purpose of the invention, the degree of crystallinity of the propylene-based matrix is measured using differential scanning calorimetry (DSC) according to ISO11357-1 and ISO11357-3 of 1997, using a scan rate of 10° C./min, a sample of 5 mg and the second heating curve using as a theoretical standard for a 100% crystalline material 207.1 J/g.

Besides the propylene-based matrix, the heterophasic propylene copolymer also comprises a dispersed ethylene-α-olefin copolymer. The dispersed ethylene-α-olefin copolymer is also referred to herein as the ‘dispersed phase’. The dispersed phase is embedded in the heterophasic propylene copolymer in a discontinuous form. The particle size of the dispersed phase is typically in the range of 0.05 to 2.0 microns, as may be determined by transmission electron microscopy (TEM). The amount of the dispersed ethylene-α-olefin copolymer in the heterophasic propylene copolymer may herein be sometimes referred as RC.

The amount of ethylene monomer units in the ethylene-α-olefin copolymer may e.g. be 20 to 65 wt %. The amount of ethylene monomer units in the dispersed ethylene-α-olefin copolymer in the heterophasic propylene copolymer may herein be sometimes referred as RCC2.

The α-olefin in the ethylene-α-olefin copolymer is preferably chosen from the group of α-olefins having 3 to 8 carbon atoms. Examples of suitable α-olefins having 3 to 8 carbon atoms include but are not limited to propylene, 1-butene, 1-pentene, 4-methyl-1-pentene, 1-hexen, 1-heptene and 1-octene. More preferably, the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer.

The MFI of the dispersed ethylene α-olefin copolymer (before the heterophasic propylene copolymer is mixed into the composition of the invention), MFIrubber, may be for example at least 0.001 dg/min, at least 0.01 dg/min, at least 0.1 dg/min, at least 0.3 dg/min, at least 0.7 dg/min, at least 1 dg/min, and/or for example at most 30 dg/min, at most 20 dg/min, at most 15 dg/min at most 10 dg/min, at most 5 dg/min or at most 3 dg/min. The MFIrubber may be in the range for example from 0.001 to 30 dg/min, for example from 0.01 to 20 dg/min, for example 0.1 to 15 dg/min, for example 0.3 to 10 dg/min, for example from 0.7 to 5 dg/min, for example from 1 to 3 dg/min. MFIrubber is calculated according to the following formula:

$$MFIrubber = 10 \hat{} \frac{Log MFIheterophasic - matrix content * Log MFImatrix}{rubber content} )$$

wherein
MFIheterophasic is the MFI (dg/min) of the heterophasic propylene copolymer measured according to ISO1133 (2.16 kg/230° C.),
MFImatrix is the MFI (dg/min) of the propylene-based matrix measured according to ISO1133 (2.16 kg/230° C.),
matrix content is the fraction of the propylene-based matrix in the heterophasic propylene copolymer,
rubber content is the fraction of the dispersed ethylene-α-olefin copolymer in the heterophasic propylene copolymer. The sum of the matrix content and the rubber content is 1. For the avoidance of any doubt, Log in the formula means log₁₀.

The dispersed ethylene-α-olefin copolymer is present in an amount of 50 to 5 wt % based on the total heterophasic propylene copolymer. Preferably, the dispersed ethylene-α-olefin copolymer is present in an amount of 40 to 15 wt %, for example in an amount of at least 22 wt % and/or for example in an amount of at most 35 wt % or at most 30 wt % based on the total heterophasic propylene copolymer.

In the heterophasic propylene copolymer in the composition of the invention, the sum of the total weight of the propylene-based matrix and the total weight of the dispersed ethylene-α-olefin copolymer may be at least 95 wt %, at least 97 wt %, at least 99 wt % or 100 wt % of the heterophasic propylene copolymer.

The α-olefin in the ethylene-α-olefin copolymer is preferably chosen from the group of α-olefins having 3 to 8 carbon atoms and any mixtures thereof, preferably the α-olefin in the ethylene-α-olefin copolymer is chosen from the group of α-olefins having 3 to 4 carbon atoms and any mixture thereof, more preferably the α-olefin is propylene, in which case the ethylene-α-olefin copolymer is ethylene-propylene copolymer. Examples of suitable α-olefins having 3 to 8 carbon atoms, which may be employed as ethylene comonomers to form the ethylene α-olefin copolymer include but are not limited to propylene, 1-butene, 1-pentene, 4-methyl-1-pentene, 1-hexen, 1-heptene and 1-octene.

The elastomer of ethylene and α-olefin comonomer having 4 to 8 carbon atoms may for example have a density in the range from 0.850 to 0.915 g/cm³. Such elastomers are sometimes also referred to as plastomers.

The α-olefin comonomer in the elastomer is preferably an acyclic monoolefin such as 1-butene, 1-pentene, 1-hexene, 1-octene, or 4-methylpentene.

Accordingly, the elastomer is preferably selected from the group consisting of ethylene-1-butene copolymer, ethylene-1-hexene copolymer, ethylene-1-octene copolymer and mixtures thereof, more preferably wherein the elastomer is selected from ethylene-1-octene copolymer. Most preferably, the elastomer is an ethylene-1-octene copolymer.

Preferably, the density of the elastomer is at least 0.865 g/cm³ and/or at most 0.910 g/cm³. For example, the density of the elastomer is at least 0.850, for example at least 0.865, for example at least 0.88, for example at least 0.90 and/or for example at most 0.915, for example at most 0.910, for example at most 0.907, for example at most 0.906 g/cm³. More preferable the density of the elastomer is in the range from 0.88 up to an including 0.907 g/cm³, most preferably, the density of the elastomer is in the range from 0.90 up to and including 0.906 g/cm³.

Elastomers which are suitable for use in the current invention are commercially available for example under the trademark EXAC™ available from Exxon Chemical Company of Houston, Texas or under the trademark ENGAGE™ polymers, a line of metallocene catalyzed plastomers available from Dow Chemical Company of Midland, Michigan or under the trademark TAFMER™ available from MITSUI Chemicals Group of Minato Tokyo or under the trademark Nexlene™ from SK Chemicals.

The elastomers may be prepared using methods known in the art, for example by using a single site catalyst, i.e., a catalyst the transition metal components of which is an organometallic compound and at least one ligand of which has a cyclopentadienyl anion structure through which such ligand bondingly coordinates to the transition metal cation. This type of catalyst is also known as “metallocene” catalyst. Metallocene catalysts are for example described in U.S. Pat. Nos. 5,017,714 and 5,324,820. The elastomer s may also be prepared using traditional types of heterogeneous multi-sited Ziegler-Natta catalysts.

Preferably, the elastomer has a melt flow index of 0.1 to 40 dg/min (ISO1133, 2.16 kg, 190° C.), for example at least 1 dg/min and/or at most 35 dg/min. More preferably, the elastomer has a melt flow index of at least 1.5 dg/min, for example of at least 2 dg/min, for example of at least 2.5 dg/min, for example of at least 3 dg/min, more preferably at least 5 dg/min and/or preferably at most 30 dg/min, more preferably at most 20 dg/min, more preferably at most 10 dg/min measured in accordance with ISO 1133 using a 2.16 kg weight and at a temperature of 190° C.

Preferably, the amount of ethylene incorporated into the elastomer is at least 50 mol %. More preferably, the amount of ethylene incorporated into the elastomer is at least 57 mol %, for example at least 60 mol %, at least 65 mol % or at least 70 mol %. Even more preferably, the amount of ethylene incorporated into the elastomer is at least 75 mol %. The amount of ethylene incorporated into the elastomer may typically be at most 97.5 mol %, for example at most 95 mol % or at most 90 mol %.

In some preferred embodiments, the second thermoplastic polymer in the second thermoplastic polymer composition is a mixture of a propylene homopolymer and a heterophasic propylene copolymer.

### Additives in Thermoplastic Polymer Composition of Polymer Sheath

The second thermoplastic polymer composition of the polymer sheath may contain other usual additives, for instance nucleating agents and clarifiers, stabilizers, fillers, plasticizers, anti-oxidants, lubricants, antistatics, scratch resistance agents, impact modifiers, acid scavengers, recycling additives, coupling agents, anti-microbials, anti-fogging additives, slip additives, anti-blocking additives, polymer processing aids, flame retardants, colorants and the like. Such additives are well known in the art. The skilled person will know how to choose the type and amount of additives such that they do not detrimentally influence the aimed properties. The amount of the additives may e.g. be 0.1 to 50 wt % of the thermoplastic polymer composition, for example 0.1 to 25 wt % or 1.0 to 5.0 wt %.

In some preferred embodiments, the additives in the thermoplastic polymer composition of the polymer sheath comprises a coupling agent.

Suitable examples of the coupling agent include a functionalized polyolefin grafted with an acid or acid anhydride functional group. The polyolefin is preferably polyethylene or polypropylene, more preferably polypropylene. The polypropylene may be a propylene homopolymer or a propylene copolymer. The propylene copolymer may be a propylene-α-olefin copolymer consisting of at least 70 wt % of propylene and up to 30 wt % of α-olefin, for example ethylene, for example consisting of at least 80 wt % of propylene and up to 20 wt % of α-olefin, for example consisting of at least 90 wt % of propylene and up to 10 wt % of α-olefin, based on the total weight of the propylene-based matrix. Preferably, the α-olefin in the propylene-α-olefin copolymer is selected from the group of α-olefins having 2 or 4-10 carbon atoms and is preferably ethylene. Examples of the acid or acid anhydride functional groups include (meth)acrylic acid and maleic anhydride. A particularly suitable material is for example maleic acid functionalized propylene homopolymer (for example Exxelor PO 1020 supplied by Exxon).

The amount of the coupling agent may e.g. be 0.5 to 3.0 wt %, preferably 1.0 to 2.0 wt %, based on the sheathed continuous multifilament strand.

### Core

The sheathed continuous multifilament strand comprises a core that extends in the longitudinal direction. The core comprises at least one continuous multifilament strand.

The continuous multifilament strand comprises a plurality of coated filaments which are bundled. The continuous multifilament strand may further comprise non-coated inorganic filaments, but preferably at least 50 wt %, at least 60 wt %, at least 70 wt %, at least 80 wt %, at least 90 wt %, at least 95 wt %, at least 98 wt %, at least 99 wt % of the multifilament strand is the coated inorganic filaments according to the invention. The continuous multifilament strand may consist of the coated inorganic filaments according to the invention.

In some embodiments, the core consists of the continuous multifilament strand (i.e. not impregnated). In other embodiments, the core comprises or consists of an impregnated continuous multifilament strand comprising the continuous multifilament strand and an impregnating agent. Preferably, the at least one impregnated continuous multifilament strands form at least 90 wt %, more preferably at least 93 wt %, even more preferably at least 95 wt %, even more preferably at least 97 wt %, even more preferably at least 98 wt %, for example at least 99 wt % of the core.

In the context of the invention with ‘extends in the longitudinal direction’ is meant ‘oriented in the direction of the long axis of the sheathed continuous multifilament strand’.

### Inorganic Filaments of Sheathed Continuous Multifilament Strand of Core

The continuous multifilament strand comprises a plurality of coated filaments which are bundled. Each of the coated filaments is a coated filament comprising an inorganic filament and a first polymer composition comprising a first thermoplastic polymer, wherein the first polymer composition is in direct contact with the filament.

Since the first polymer composition is in direct contact with the filament, this means that there are no components present between the surface of the glass filament and the coating layer, so this means that there are no adhesion promoters, sizings or similar compounds between the first polymer composition and the inorganic filament. Typically in conventional processes, adhesion promoters or sizings are first applied to the inorganic filament before coating with a polymer composition.

The process described below eliminates the need for coatings with adhesion promoters or the like between the glass filament and the first polymer composition.

The inorganic filament can be a mineral material, e.g., engineering glasses (electrical glasses (E glasses, alumino-borosilicate glasses with less than 1 wt % alkali oxides); A glasses (alkali-lime glasses with little to no boron oxide); AR glasses; electrical/chemical resistance glasses (E-CR glasses, alumino-lime-silicate glasses with less than 1 wt. % alkali oxides and with high acid resistance); C glasses (alkali-lime glasses with high boron oxide content, also T glasses); D glasses (borosilicate glasses with low dielectric constant); R glasses (aluminosilicate glasses without MgO and CaO); S glasses (aluminosilicate glasses without CaO but with high MgO content); M glasses; or basalt; kaolin; alkaline earth silicate (AES, combination of CaO, MgO and SiO₂); refractory ceramic fibers (RCF, also aluminosilicate, ASW); polycrystalline wool (PCW, contains over 70% alumina); alumina; metallic materials (steel alloys; aluminum alloys; copper alloys, platinum alloys and pure platinum, especially alloys with rhodium).

Preferred inorganic filament is a glass filament such as a filament of E glass or E-CR glass.

The first polymer composition comprises a first thermoplastic polymer, for example in an amount of at least 95 wt %, for example in an amount of at least 96 wt, preferably in an amount of at least 97 wt %, for example in an amount of at least 98.5 wt % based on the first polymer composition and may optionally contain additives, for example in an amount from 0.1 to 5.0 wt % based on the first polymer composition.

Preferably, the first polymer composition comprises at least 95 wt %, for example in an amount of at least 96 wt, preferably in an amount of at least 97 wt %, for example in an amount of at least 98.5 wt % of the first thermoplastic polymer based on the first polymer composition and/or wherein the first thermoplastic polymer is chosen from the group of acrylonitrile butadiene styrene (ABS), acrylonitrile styrene acrylate (ASA), polyethylene (PE), polyolefin elastomer (POE), polyethylene terephthalate (PET), polypropylene (PP), polyvinyichloride (PVC), polybutadiene (BR), ethylene propylene diene monomer (EPDM, polyamide (PA), thermoplastic polyurethane (TPU) and mixtures thereof, preferably wherein the first thermoplastic polymer is a polypropylene.

The first thermoplastic polymer may be selected from the group consisting of: Polymers soluble in trichloromethane, tetrachloromethane or 1-bromonaphthalene such as acrylic polymers (acrylonitrile-butadiene-styrenes (ABS), acrylonitrile-styrene-acrylates (ASA), polyisobutyl methacrylates (PiBMA), poly-n-butyl methacrylates (PnBMA), polyethyl methacrylate (PEMA), polymethyl methacrylates (PMMA)), cellulose acetate butyrates (CAB), fluorinated ethylene polypropylenes (FEP), polyamides (PA) such as polyamide 12 (PA-12), polybutadienes, polycarbonates (PC) such as bisphenol A polycarbonates, polychlorotrifluoroethylene (PCTFE), polyimides such as polyetherimides (PEI), polysulfones such as polyethersulfones (PES), polyethylenes (PE) such as UHMWPE, HMWPE, HDPE, LLDPE, LDPE, Polyethylene terephthalates (PET), polyisobutylenes (PiB, butyl rubber), polyisoprenes (PiP), polylactic acids (PLA), polyphenylene oxides (PPO), polyphenylene sulfides (PPS), Polypropylenes (PP), atactic PP, isotactic PP, polystyrenes (PS), polysulfones (PSU), polyurethanes (PU), polyvinyl acetates (PVA), polyvinyl butyrals, Polyvinyl chlorides (PVC), bromosoluble polymers, acrylic polymers, polyethyl methacrylates (PEMA), polymethyl methacrylates (PMMA), cellulose acetates (CA), cellulose acetate butyrates (CAThB), nitrocelluloses (cellulose nitrates), polycarbonates (PC), bisphenol A polycarbonates, polyphenylene oxides (PPO), polyurethanes (PU), polyvinyl acetates (PVA).

Preferably, the first polymer composition has a melt viscosity of at most 25 Pa·s, preferably in the range from 1.0 to 25 Pa·s, more preferably in the range from 1.0 to 20 Pa·s, even more preferably in the range from 1.8 to 19.4 Pas or in the range from 1.0 to 15 Pa·s, even more preferably in the range from 1.0 to 10 Pa·s, most preferably 1.0 to 5.0 Pa·s at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%.

The first polymer composition can comprise or can be a polypropylene composition comprising A) a grafted polypropylene grafted with C1) a side chain compound capable of forming hydrogen bond and/or
B) a non-grafted polypropylene and C2) a compound capable of forming hydrogen bond,
wherein the total amount of A) and B) with respect to the polypropylene composition is at least 70 wt % and the polypropylene composition comprises D) a low molecular weight polyethylene, for example a low molecular weight polyolefin having molecular weight of at most 5000 g/mol in an amount of less than 10 wt % with respect to the polypropylene composition.

The use of an adhesion promoter, preferably a side chain compound capable of forming hydrogen bond or/and a compound capable of forming hydrogen bond in the polymer composition improves the adhesion between the polymer composition and the inorganic filament. Surprisingly, it was found that it is possible to produce coated filaments in which the adhesion promoter is contained in the polymer composition itself rather than as an interlayer. This simplifies the production process.

The coated inorganic filament may be in the form of a single inorganic filament provided with a coating layer. In this case, the coating layer can be provided over substantially the whole or part of the surface of the inorganic filament. The coated inorganic filament may be in the form of a plurality of inorganic filaments which are (partly) bundled together. In this case, the coating layer may not be present on the parts of the inorganic filaments in contact with each other.

The coated glass filament comprises a coating layer of the first polymer composition, preferably a polypropylene composition provided directly on the glass filament.

Preferably, the polypropylene composition used comprises C1) a side chain compound capable of forming hydrogen bond (as part of the grafted polypropylene) and/or C2) a compound capable of forming hydrogen bond. The presence of C1) and/or C2) in the polypropylene composition improves adhesion to glass fibers. The compounds C1) and C2) have a hydrogen atom or have a functional group which generates a hydrogen atom by (partial) hydrolyzation of the group, which is capable of forming hydrogen bond with the glass filaments. The hydrogen bond improves adhesion of the polypropylene composition to the glass filaments. In some cases, in addition to forming hydrogen bond, condensation reactions between silanol groups on the glass surface and the hydrogen atom can create an ester or ether linkage and thus result in a covalent bond to the glass surface.

Preferably, the polypropylene composition comprises
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof;
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof and
B) a non-grafted polypropylene;
A) a grafted polypropylene grafted with C1) a side chain compound selected from the group consisting of anhydrides (e.g. maleic anhydride, itaconic anhydride), vinyl-oligosilane, acryloxy-oligosilane, epoxy (meth)acrylates and combinations thereof,
B) a non-grafted polypropylene and
C2) a compound selected from oligosilanes (e.g. vinyl-oligosilane, aminopropyl-oligosilane, acryloxy-oligosilane), a copolymer of ethylene and 2-hydroxyethyl methacrylate, epoxy (meth)acrylates, polyamides, an organometallic compound having a pyrophosphate group and combinations thereof; or
B) a non-grafted polypropylene and
C2) a compound selected from vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

### A) Grafted Polypropylene

The polypropylene composition used may comprise a grafted polypropylene. The grafted polypropylene is a polypropylene grafted with C1) a side chain compound capable of forming hydrogen bond.

Suitable examples of C1) include anhydrides (e.g. maleic anhydride, itaconic anhydride), oligosilanes (e.g. vinyl-oligosilane, aminopropyl-oligosilane, acryloxy-oligosilane), epoxy (meth)acrylates, polyamides, and combinations thereof. The skilled person knows how to obtain A) by grafting C1) to polypropylene. When C1) is maleic anhydride, the double bond of maleic anhydride is consumed to achieve grafting and succinic anhydride linkages to the polypropylene are made.

An example of epoxy(meth)acrylates is glycidyl methacrylate.

Preferably, C1) comprises anhydrides (e.g. maleic anhydride, itaconic anhydride). Most preferably, C1) comprises maleic anhydride. This result in a good adhesion between the polypropylene composition and the filaments.

Preferably, the amount of C1) with respect to the amount of A) is 0.5 to 10 wt %, for example 0.6 to 5.0 wt %, 0.7 to 3.0 wt %, 0.8 to 2.0 wt %.

### C2) Compound Capable of Forming Hydrogen Bond

The polypropylene composition used may comprise B) a non-grafted polypropylene and C2) a compound capable of forming hydrogen bond. Preferably, C2) has an unsaturated group which can react with the non-grafted polypropylene to form the hydrogen bond or C2) has a hydrophobic group (e.g. copolymer of ethylene and 2-hydroxyethyl methacrylate (PE-HEMA).

Suitable examples of C2) include oligosilanes (e.g. vinyl-oligosilane, aminopropyl-oligosilane, acryloxy-oligosilane), a copolymer of ethylene and 2-hydroxyethyl methacrylate (PE-HEMA), epoxy (meth)acrylates, polyamides, an organometallic compound having a pyrophosphate group and combinations thereof.

When the polypropylene composition comprises A), C2) is preferably a compound selected from oligosilanes (e.g. vinyl-oligosilane, aminopropyl-oligosilane, acryloxy-oligosilane), a copolymer of ethylene and 2-hydroxyethyl methacrylate (PE-HEMA), epoxy (meth)acrylates, polyamides, an organometallic compound having a pyrophosphate group and combinations thereof.

When the polypropylene composition does not comprise A), C2) is preferably a compound selected from vinyl-oligosilane, acryloxy-oligosilane, a copolymer of ethylene and 2-hydroxyethyl methacrylate, epoxy (meth)acrylates, an organometallic compound having a pyrophosphate group and combinations thereof.

Preferably, C2) is selected from the group consisting of oligosilanes (e.g. vinyl-oligosilane, aminopropyl-oligosilane, acryloxy-oligosilane), an organometallic compound having a pyrophosphate group and combinations thereof. This result in a good adhesion between the polypropylene composition and the filaments. Preferably, C2) comprises a vinyl-oligosilane or an acryloxy-oligosilane, more preferably a vinyl-oligosilane. This result in a particularly good adhesion between the polypropylene composition and the filaments.

Oligosilanes were found to have volatility which is low enough to react with polypropylene to achieve the desired effect.

Preferably, the polypropylene composition is free of or is substantially free of an alkoxysilane compound having molecular weight of less than 300 (e.g. γ-aminopropyltriethoxysilane (APTES), γ-glycidoxypropyltrimethoxysilane (GPTMS), γ-methacryloxypropyltrimethoxysilane (MPTMS), vinyltriethoxysilane (VTES)). Preferably, the amount of such alkoxysilane compound having molecular weight of less than 300 with respect to the polypropylene composition is less than 10 wt %, less than 5.0 wt %, less than 3.0 wt %, less than 1.0 wt %, less than 0.5 wt % or 0 wt %.

Preferably, C2) comprises an organometallic compound having a pyrophosphate group, preferably a titanate pyrophosphate compound or a zirconate pyrophosphate compound. This result in a particularly good adhesion between the polypropylene composition and the filaments. Suitable examples include neopentyl(diallyl)oxy tri(dioctyl) pyrophosphato titanate, cyclo(dioctyl)pyrophosphate dioctyl titanate, dicyclo(dioctyl)pyrophosphate titanate, neopentyl(diallyl)oxy tri(N-ethylenediamineo)ethyl titanate, cyclo[dineopentyl(diallyl)]pyrophosphato dineopentyl(diallyl)zirconate, di(dioctyl)pyrophosphate oxoethylene titanate and the 2-(N,N-dimethylamino)isobutanol adduct of di(dioctyl)pyrophosphate oxoethylene titanate.

Preferably, the amount of C2) with respect to the total amount of B) and C2) is 0.2 to 10 wt %, for example 0.3 to 5.0 wt %, 0.4 to 3.0 wt %, 0.5 to 2.0 wt %.

### D) Low Molecular Weight Polyolefin

The polypropylene composition comprises D) a low molecular weight polyethylene having number average molecular weight of at most 5000 g/mol in an amount of less than 10 wt % with respect to the polypropylene composition. It will be appreciated that this includes the situation where the polypropylene composition does not comprise D) a low molecular weight polyethylene having number average molecular weight of at most 5000 g/mol. If the polypropylene composition comprises D) a low molecular weight polyethylene having number average molecular weight of at most 5000 g/mol, its amount with respect to the polypropylene composition is less than 10 wt %. Accordingly, this feature may also be expressed as “the amount of D) a low molecular weight polyethylene having number average molecular weight of at most 5000 g/mol in the polypropylene composition is less than 10 wt % with respect to the polypropylene composition”.

Preferably, the polypropylene composition is free of or is substantially free of a low molecular weight polyethylene having a number average molecular weight of at most 5000 g/mol. Preferably, the amount of such low molecular weight polyethylene with respect to the polypropylene composition is less than 10 wt %, less than 5.0 wt %, less than 3.0 wt %, less than 1.0 wt %, less than 0.5 wt % or 0 wt %.

Preferably, the polypropylene composition is free of or is substantially free of a low molecular weight polyolefin having number average molecular weight of at most 5000 g/mol. For example, the amount of such low molecular weight polyolefin (total of low molecular weight polyethylene having number average molecular weight of at most 5000 g/mol and any other polyolefins having number average molecular weight of at most 5000 g/mol) with respect to the polypropylene composition is less than 10 wt %, less than 8.0 wt %, less than 5.0 wt %, less than 3.0 wt %, less than 1.0 wt %, less than 0.5 wt % or 0 wt %.

### Additives

The first polymer composition may further comprise additives, such as for example flame retardants, pigments, lubricants, slip agents flow promoters, antistatic agents, processing stabilizers, long term stabilisers and/or UV stabilizers. The amount of the additives may e.g. be 0.1 to 5.0 wt %.

Preferably, the total amount of A), B), C2), D) and the additives is 100 wt % with respect to the first polymer composition.

### Preferred Polypropylene Compositions

Preferably, the polypropylene composition has a melt viscosity of at most 25 Pa·s, preferably in the range from 1.0 to 25 Pa·s, more preferably in the range from 1.0 to 20 Pa·s, even more preferably in the range from 1.8 to 19.4 Pas or in the range from 1.0 to 15 Pa·s, even more preferably in the range from 1.0 to 10 Pa·s, most preferably 1.0 to 5.0 Pa·s at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%.

In some preferred embodiments, the amount of A) with respect to the polypropylene composition in an amount of at least 50 wt %, at least 60 wt %, at least 70 wt %, at least 80 wt %, at least 90 wt %, at least 95 wt %, at least 98 wt %, at least 99 wt % or 100 wt %. In some preferred embodiments, the total amount of B) and C2) with respect to the polypropylene composition in an amount of at least 50 wt %, at least 60 wt %, at least 70 wt %, at least 80 wt %, at least 90 wt %, at least 95 wt %, at least 98 wt %, at least 99 wt % or 100 wt %.

In some preferred embodiments, the polypropylene composition comprises A) and B). Preferably, the total amount of A) and B) with respect to the polypropylene composition is at least 70 wt %, at least 80 wt %, at least 90 wt %, at least 93 wt %, at least 95 wt %, at least 97 wt %, at least 99 wt % or 100 wt %. Preferably, the amount of A) with respect to the total amount of A) and B) is 1.0 to 30 wt %, for example 2.0 to 25 wt %, 3.0 to 20 wt % or 4.0 to 10 wt %.

In some preferred embodiments, the polypropylene composition comprises A). B) and C2). Preferably, the amount of B) with respect to the total amount of A), B) and C2) is at least 65 wt %. Preferably, the amount of A) with respect to the total amount of A) and B) is 1.0 to 30 wt %, for example 2.0 to 25 wt %, 3.0 to 20 wt % or 4.0 to 10 wt %. Preferably, the amount of C2) with respect to the total amount of B) and C2) is 0.2 to 10 wt %, for example 0.3 to 5.0 wt %, 0.4 to 3.0 wt %, 0.5 to 2.0 wt %. In particularly preferred embodiments, the amount of A) is 1.0 to 5.0 wt %, the amount of B) is 90 to 98 wt %, the amount of C) is 1.0 to 5.0 wt %, with respect to the total amount of A), B) and C).

In particularly preferred embodiments where the polypropylene composition comprises A). B) and C2). C1) is selected from the group consisting of anhydrides (e.g. maleic anhydride, itaconic anhydride) and C2) comprises an organometallic compound having a pyrophosphate group, preferably a titanate pyrophosphate compound or a zirconate pyrophosphate compound.

In some embodiments, after the bundle plurality of coated filaments is obtained a sizing composition is applied to the bundle. In these cases the continuous multifilament comprises a sizing composition provided on the plurality of coated filaments which are bundled. It will be appreciated that such sizing composition is not present between the glass filament and the first polymer composition.

The sizing composition can comprise a silane compound which may be tri(C₁₋₆ alkoxy)mono amino silane, tri(C₁₋₆ alkoxy)diamino silane, tri(C₁₋₆ alkoxy)(C₁₋₆ alkyl ureido) silane, tri(C₁₋₆ alkoxy)(epoxy C₁₋₆ alkyl) silane, tri(C₁₋₆ alkoxy)(glycidoxy C₁₋₆ alkyl) silane, tri(C₁₋₆ alkoxy)(mercapto C₁₋₆ alkyl) silane, or a combination thereof. For example, the silane compound is (3-aminopropyl)triethoxy silane, (3-glycidoxypropyl)trimethoxysilane, (2-(3,4-epoxycyclohexyl)ethyl)triethoxysilane, (3-mercaptopropyl)trimethoxysilane, (3-(2-aminoethylamino)propyl)triethoxysilane, (3-ureidopropyl)triethoxy silane, or a combination thereof.

In some embodiments, the continuous multifilament is free of a sizing composition. After the bundle of the plurality of coated filaments is obtained, the continuous multifilament is directly provided with the polymer sheath or directly impregnated with an impregnating agent.

### Core Comprising No Impregnating Agent

In some embodiments, the core is substantially free from an impregnating agent. The absence of impregnating agent in the composition has a particular advantage in the simplicity of the process and the reduction of the volatile compounds.

This is achieved by the process for preparing the fiber reinforced thermoplastic polymer composition in which step c) is performed directly after step a) without step b).

Such core is described e.g. in WO2022128783A1.

Preferably, the sheathed continuous multifilament strand comprises a polyethylene wax having a melting point of 50 to 100° C., MW of 5 to 10 kg/mol and a polydispersity index (MWD) of 5 to 10 in an amount of less than 0.50 wt %, preferably less than 0.40 wt %, less than 0.30 wt %, less than 0.20 wt %, less than 0.10 wt %, less than 0.05 wt %, less than 0.01 wt % or 0.00 wt %, with respect to the sheathed continuous multifilament strand. An example of such a polyethylene wax is commercially available as Dicera 13082 Paramelt, which is a highly branched polyethylene wax.

Preferably, the sheathed continuous multifilament strand comprises a polyethylene wax having MW of at most 10 kg/mol in an amount of less than 0.50 wt %, preferably less than 0.40 wt %, less than 0.30 wt %, less than 0.20 wt %, less than 0.10 wt %, less than 0.05 wt %, less than 0.01 wt % or 0.00 wt %, with respect to the sheathed continuous multifilament strand.

Preferably, the sheathed continuous multifilament strand comprises a polyethylene wax having a melting point which is at least 20° C. lower than the polyolefin in the thermoplastic composition and a viscosity of from 2.5 to 100 cS determined by ASTM D 3236-15 (standard test method for apparent viscosity of hot melt adhesives and coating materials, Brookfield viscometer Model RVDV 2, #27 spindle, 5 r/min) at 160° C. in an amount of less than 0.50 wt %, preferably less than 0.40 wt %, less than 0.30 wt %, less than 0.20 wt %, less than 0.10 wt %, less than 0.05 wt %, less than 0.01 wt % or 0.00 wt %, with respect to the sheathed continuous multifilament strand.

Preferably, the sheathed continuous multifilament strand comprises a microcrystalline polyethylene wax having at least one of the following properties in an amount of less than 0.50 wt %, preferably less than 0.40 wt %, less than 0.30 wt %, less than 0.20 wt %, less than 0.10 wt %, less than 0.05 wt %, less than 0.01 wt % or 0.00 wt %, with respect to the sheathed continuous multifilament strand:
a drop melting point of from 60 to 90° C. as determined in accordance with ASTM D127
a congealing point of from 55 to 90° C. as determined in accordance with ASTMD938
a needle pen penetration at 25° C. of from 7 to 40 tenths of a mm as determined in accordance with ASTM D1321
a viscosity at 100° C. of from 10 to 25 mPa·s as determined in accordance with ASTM D445 and
an oil content of from 0 to 5 wt. % based on the weight of the microcrystalline wax as determined in accordance with ASTM D721.

Preferably, the core substantially consists of the at least one continuous multifilament. Preferably, the amount of the at least one continuous multifilament with respect to the core is at least 99.50 wt %, at least 99.60 wt %, at least 99.70 wt %, at least 99.80 wt %, at least 99.90 wt %, at least 99.95 wt %, at least 99.99 wt % or 100.00 wt %.

Preferably, the core substantially consists of the coated filaments. Preferably, the amount of the coated filaments with respect to the core is at least 50 wt %, at least 60 wt %, at least 70 wt %, at least 80 wt %, at least 90 wt %, at least 95 wt %, at least 98 wt %, at least 99 wt % at least 99.50 wt %, at least 99.60 wt %, at least 99.70 wt %, at least 99.80 wt %, at least 99.90 wt %, at least 99.95 wt %, at least 99.99 wt % or 100.00 wt %.

### Core Comprising Impregnating Agent

In some embodiments, the core comprises an impregnated continuous multifilament strand comprising the at least one continuous multifilament strand impregnated with an impregnating agent. This is achieved by the process for preparing the fiber reinforced thermoplastic polymer composition comprising b) applying an impregnating agent to the at least one continuous multifilament strand.

Suitable examples and amounts of the impregnating agent are described e.g. in WO2021156115A1.

The impregnated continuous multifilament strand is prepared from a continuous multifilament strand and an impregnating agent and in particular by applying an impregnating agent to the continuous multifilament strand preferably in an amount from 0.50 to 18.0 wt %, for example from 0.5 to 10.0 wt % or for example from 10.0 to 18.0 wt % based on the sheathed continuous multifilament strand. The optimal amount of impregnating agent applied to the continuous multifilament strand depends on the polymer sheath, on the size (diameter) of the filaments forming the continuous glass strand, and on the type of sizing composition. Typically, the amount of impregnating agent applied to the continuous multifilament strand is for example at least 0.50 wt %, preferably at least 1.0 wt %, preferably at least 1.5 wt %, preferably at least 2 wt %, preferably at least 2.5 wt % and/or at most 10.0 wt %, preferably at most 9.0 wt %, more preferably at most 8.0 wt %, even more preferably at most 7.0 wt %, even more preferably at most 6.0 wt %, even more preferably at most 5.5 wt %, or for example at least 10.0 wt %, preferably at least 11 wt %, preferably at least 12 wt % and/or at most 18 wt %, preferably at most 16 wt %, preferably at most 14% based on the amount of sheathed continuous multifilament strand. Preferably, the amount of impregnating agent is in the range from 1.5 to 8 wt %, even more preferably in the range from 2.5 wt % to 6.0 wt % based on the sheathed continuous multifilament strand. A higher amount of impregnating agent increases the Impact Energy per unit of thickness (J/mm). However, for reasons of cost-effectiveness and low emissions (volatile organic compounds) and mechanical properties, the amount of impregnating agent should also not become too high.

For example, the ratio of impregnating agent to continuous multifilament strand is in the range from 1:4 to 1:30, preferably in the range from 1:5 to 1:20.

Preferably, the viscosity of the impregnating agent is in the range from 2.5 to 200 cSt at 160° C., more preferably at least 5.0 cSt, more preferably at least 7.0 cSt and/or at most 150.0 cSt, preferably at most 125.0 cSt, preferably at most 100.0 cSt at 160° C.

An impregnating agent having a viscosity higher than 100 cSt is difficult to apply to the continuous multifilament strand. Low viscosity is needed to facilitate good wetting performance of the fibres, but an impregnating agent having a viscosity lower than 2.5 cSt is difficult to handle, e.g., the amount to be applied is difficult to control; and the impregnating agent could become volatile. For purpose of the invention, unless otherwise stated, the viscosity of the impregnating agent is measured in accordance with ASTM D 3236-15 (standard test method for apparent viscosity of hot melt adhesives and coating materials, Brookfield viscometer Model RVDV 2, #27 spindle, 5 r/min) at 160° C. Preferably, the melting point of (that is the lowest melting temperature in a melting temperature range) the impregnating agent is at least 20° C. below the melting point of the thermoplastic polymer composition. More preferably, the impregnating agent has a melting point of at least 25 or 30° C. below the melting point of the thermoplastic polymer composition. For instance, when the thermoplastic polymer composition has a melting point of about 160° C., the melting point of the impregnating agent may be at most about 140° C. Suitable impregnating agents are compatible with the thermoplastic polymer to be reinforced, and may even be soluble in said polymer. The skilled man can select suitable combinations based on general knowledge, and may also find such combinations in the art. Suitable examples of impregnating agents include low molar mass compounds, for example low molar mass oligomeric polyurethanes, polyesters such as unsaturated polyesters, polycaprolactones, polyethyleneterephthalate, poly(alpha-olefins), such as highly branched polyethylenes and polypropylenes, polyamides, such as nylons, and other hydrocarbon resins. For reinforcing polypropylenes, the impregnating agent preferably comprises highly branched poly(alpha-olefins), such as highly branched polyethylenes, modified low molecular weight polypropylenes, mineral oils, such as, paraffin or silicon and any mixtures of these compounds.

The impregnating agent preferably comprises at least 20 wt %, more preferably at least 30 wt %, more preferably at least 50 wt %, for example at least 99.5 wt %, for example 100 wt % of a branched poly(alpha-olefin), most preferably a branched polyethylene. To allow the impregnating agent to reach a viscosity of from 2.5 to 200 cSt at 160° C., the branched poly(alpha-olefin) may be mixed with an oil, wherein the oil is chosen from the group consisting of of mineral oils, such as a paraffin oil or silicon oil; hydrocarbon oils; and any mixtures thereof. Preferably, the impregnating agent is non-volatile, and/or substantially solvent-free. In the context of the present invention, non-volatile means that the impregnating agent has a boiling point or range higher than the temperatures at which the impregnating agent is applied to the continuous multifilament strand. In the context of present invention, “substantially solvent-free” means that impregnating agent contains less than 10 wt % of solvent, preferably less than 5 wt % of solvent based on the impregnating agent. In a preferred embodiment, the impregnating agent does not contain any organic solvent. The impregnating agent may further be mixed with other additives known in the art. Suitable examples include lubricants; antistatic agents; UV stabilizers; plasticizers; surfactants; nucleation agents; antioxidants; pigments; dyes; and adhesion promoters, such as a modified polypropylene having maleated reactive groups; and any combinations thereof, provided the viscosity remains within the desired range. Any method known in the art may be used for applying the liquid impregnating agent to the continuous multifilament strand. The application of the liquid impregnating agent may be performed using a die. Other suitable methods for applying the impregnating agent to the continuous multifilament strands include applicators having belts, rollers, and hot melt applicators. Such methods are for example described in documents EP0921919B1, EP0994978B1, EP0397505B1, WO2014/053590A1 and references cited therein. The method used should enable application of a constant amount of impregnating agent to the continuous multifilament strand.

Preferably, the amount of the impregnated continuous multifilament strand is 25 to 75 wt %, for example 25 to 40 wt %, 40 to 55 wt % or 55 to 75 wt %, with respect to the sheathed continuous multifilament strand. Preferably, the total amount of the impregnated continuous multifilament strand and the polymer sheath is 100 wt % with respect to the sheathed continuous multifilament strand.

Other suitable examples of the impregnating agent include an aromatic phosphate ester, polyphosphonate and poly(phosphonate-co-carbonate).

Preferably, the aromatic phosphate ester is selected from the group consisting of resorcinol bis(diphenyl phosphate);
tetraphenyl resorcinol bis(diphenylphosphate);
bisphenol A bis(diphenyl phosphate);
bisphenol A diphosphate;
resorcinol bis(di-2,6-xylyl phosphate),
phosphoric acid, mixed esters with [1,1′-biphenyl]-4-4′-diol and phenol;
phosphorictrichloride, polymer with 1,3-benzenediol,phenylester;
1,3-phenylene-tetrakis(2,6-dimethylphenyl)diphosphate;
isopropenylphenyl diphenyl phosphate;
4-phenylphenolformaldehyde phenylphosphonate;
tris(2,6-xylyl) phosphate;
resorcinol bis(di-2,6-xylyl phosphate);
bisphenol S bis(diphenyl phosphate); and
resorcinol-bisphenol A phenyl phosphates and
combinations thereof,
preferably the aromatic phosphate ester is bisphenol A bis(diphenyl phosphate).

In particularly preferred embodiments, the inorganic filament is a glass filament, the first thermoplastic polymer is a polypropylene and the second thermoplastic polymer is a polypropylene and
the core is substantially free from an impregnating agent and/or the sheathed continuous multifilament strand comprises a polyethylene wax having a melting point of 50 to 100° C., MW of 5 to 10 kg/mol and a polydispersity index (MWD) of 5 to 10 in an amount of less than 0.50 wt %.

### Further Aspects

The invention provides pellets comprising or consisting of the fiber reinforced thermoplastic polymer composition according to the invention.

The pellets may typically have a length of from 2 to 50 mm, preferably from 5 to 30 mm, more preferably from 6 to 20 and most preferably from 10 to 16 mm. The length of the filaments is typically substantially the same as the length of the pellet.

The total amount of the second thermoplastic polymer composition and the continuous multifilament strand and the optional impregnating agent in the pellet is preferably at least 95 wt %, at least 98 wt %, at least 99 wt %, at least 99.9 wt % or 100 wt % with respect to the pellet.

The pellets may be molded into (semi-)finished articles. Suitable examples of mold molding processes include injection molding, compression molding, extrusion (optionally followed by thermoforming) and extrusion compression molding. The molding may be performed by melting and molding the pellets according to the invention with or without an addition of (pellets of) a further polymer.

The present invention further relates to a molded article comprising the fiber reinforced thermoplastic polymer composition.

The molded article may be an injection molded article. The article may be selected from automotive exterior parts like bumpers and tailgates, automotive interior parts like instrument panels, automotive parts under the bonnet. The article may be also be selected from parts and housings of air conditioners, dishwashers, washing machines, dryers, coffee machines, power tools (e.g. saws, drills), durable goods (e.g. furniture), 5G antennas, solar panels, bikes and steps.

The molded article may be an extruded and optionally thermoformed article, wherein the article is selected from the group consisting of scaffoldings, battery trays, construction frames and flooring.

The present invention further relates to a process for preparing a molded article by melt-mixing and molding (pellets of) the fiber reinforced thermoplastic polymer composition according to the invention.

The present invention further relates to a process for preparing a molded article by melting and molding (pellets of) the fiber reinforced thermoplastic polymer composition according to the invention and (pellets of) a further polymer. Preferably, the amount of the multifilament strand is 50 to 80 wt % with respect to the sheathed continuous multifilament strand. Suitable examples of such further polymer is a propylene-based polymer described in relation to the thermoplastic polymer composition of the polymer sheath. WO2022/128784 describes suitable examples of such further polymer as “further propylene-based polymer”, incorporated herein by reference.

It is noted that the invention relates to the subject-matter defined in the independent claims alone or in combination with any possible combinations of features described herein, preferred in particular are those combinations of features that are present in the claims. It will therefore be appreciated that all combinations of features relating to the composition according to the invention; all combinations of features relating to the process according to the invention and all combinations of features relating to the composition according to the invention and features relating to the process according to the invention are described herein.

It is further noted that the term ‘comprising’ does not exclude the presence of other elements. However, it is also to be understood that a description on a product/composition comprising certain components also discloses a product/composition consisting of these components. The product/composition consisting of these components may be advantageous in that it offers a simpler, more economical process for the preparation of the product/composition. Similarly, it is also to be understood that a description on a process comprising certain steps also discloses a process consisting of these steps. The process consisting of these steps may be advantageous in that it offers a simpler, more economical process.

The invention is now elucidated by way of the following examples, without however being limited thereto.

### EXAMPLES

### Materials Used

GF1: a glass roving having a diameter of 19 micron and a tex of 3000 (tex means grams glass per 1000m) containing a sizing composition comprising a silane coupling agent.

GF2: a bundle (package) of a continuous glass multifilament of a plurality of bundled coated glass filaments. The coated glass filament comprises a glass filament and a coating layer of a polypropylene composition provided directly on the glass filament. The amount of the polypropylene composition is about 4.5 wt % with respect to the continuous glass multifilament. The polypropylene composition comprises 10 wt % of Bondyram 1010 from Bondyram (polypropylene grafted with maleic anhydride), 15 wt % of PP595A from SABIC (propylene homopolymer having MFR according to ISO1133 at 230° C. and 2.16 kg of 47 dg/min) and 75 wt % of PP514M12 from SABIC (propylene homopolymer having MFR according to ISO1133 at 230° C. and 2.16 kg of >1000 dg/min). The bundle coated with the polypropylene composition was further provided with a sizing composition comprising an aminosilane compound.

Impregnating agent 1: wax commercially available as IGI Paraflex 4838A

PP1: SABIC PP 595A Polypropylene homopolymer with following properties: density: 905 kg/m³, melt flow index: 45 dg/min at 230° C. and 2.16 kg (test method: ISO1133)

Exxelor PO1020: polypropylene grafted with maleic anhydride from ExxonMobil: density: 900 kg/m³, melting point: 162° C., melt flow index: 430 dg/min at 230° C. and 2.16 kg (testing method: ASTM D1238)

AO1076: antioxidant 1076 from BASF

AOB225: antioxidant B225 from BASF

UV119: UV stabilizer UV 119 from SABO SpA

UV770: UV stabilizer UV 770 from BASF

CMB black: color masterbatch from Ampacet

### CEx 1

Pellets of sheathed continuous multifilament strands were prepared using components given in Table 1 using the wire coating process as described in details in the examples of WO2009/080281A1.

Impregnating agent 1 was applied to GF1 to obtain an impregnated continuous glass multifilament strand.

Polypropylene and additives shown in table 1 were fed to the extruder to sheath the impregnated continuous glass multifilament strand using an extruder-head wire-coating die. The sheathing step was performed in-line directly after the impregnating step. The obtained sheathed continuous multifilament strand was cut into pellets having length of 8-15 mm and diameter of 3-4 mm. The obtained pellets were molded using ARBURG 320T injection molding machine to prepare the samples for testing.

### Ex 2

Pellets of sheathed continuous multifilament strands were prepared using components given in Table 1 using the process as in CEx 1 except that the step of applying the impregnating agent was not performed.

Following properties were measured and are shown in Table 1.

Flexural performance was tested after 7 days at 23° C. aging according to ISO178.

Tensile performance was tested after 7 days at 23° C. aging according to ISO527.

TABLE 1

| | | CEx 1 | Ex 2 |
|---|---|---|---|
| PP1 | wt % | 52.94 | 56.94 |
| Impreg. Agent | wt % | 4 | |
| GF1 | | 40.2 | |
| GF2 | wt % | | 40.2 |
| Exxelor PO 1020 | | 2.0 | 2.0 |
| AO B225 | wt % | 0.2 | 0.2 |
| UV 119 | wt % | 0.06 | 0.06 |
| CMB black | wt % | 0.6 | 0.6 |
| Total | wt % | 100.00 | 100.00 |
| Flexural modulus | MPa | 8195 | 10542 |
| Flexural stress at break | MPa | 182 | 216 |
| Tensile modulus | MPa | 8196 | 9890 |
| Tensile strength | MPa | 117 | 124 |

The composition of Ex 2 which comprises GF1 (provided with a polypropylene composition instead of sizing composition) and which does not comprise an impregnating agent has better mechanical properties than the composition of CEx 1 which comprises GF2 (provided with sizing composition) and which comprises an impregnating agent.

1. A fiber reinforced thermoplastic polymer composition comprising a sheathed continuous multifilament strand comprising a core that extends in the longitudinal direction and a polymer sheath which intimately surrounds said core,
wherein the core comprises at least one continuous multifilament strand comprising a plurality of coated filaments which are bundled,
wherein each of the coated filaments is a coated filament comprising an inorganic filament and a first polymer composition comprising a first thermoplastic polymer,
wherein the first polymer composition is in direct contact with the filament,
wherein the polymer sheath consists of a second thermoplastic polymer composition comprising a second thermoplastic polymer.

2. The fiber reinforced thermoplastic polymer composition according to claim 1, wherein the plurality of coated filaments which are bundled are obtainable by a method comprising the steps of:
i) producing an uncoated inorganic filament from an inorganic melt;
ii) providing a melt of the first polymer composition comprising the first thermoplastic polymer;
iii) applying the melt of the first polymer composition to the uncoated inorganic filament and allowing the melt of the first polymer composition to solidify;
iv) obtaining a coated filament comprising an inorganic filament which is coated with the first polymer composition and wherein the inorganic filament is in direct contact with the first polymer composition and
v) bundling a plurality of said coated filaments.

3. The fiber reinforced thermoplastic polymer composition according to claim 1, wherein the first polymer composition comprises at least 95 wt % of the first thermoplastic polymer based on the polymer composition and/or wherein the first thermoplastic polymer is chosen from the group of acrylonitrile butadiene styrene (ABS), acrylonitrile styrene acrylate (ASA), polyethylene (PE), polyolefin elastomer (POE), polyethylene terephthalate (PET), polypropylene (PP), polyvinylchloride (PVC), polybutadiene (BR), ethylene propylene diene monomer (EPDM, polyamide (PA), thermoplastic polyurethane (TPU) and mixtures thereof.

4. The fiber reinforced thermoplastic polymer composition according to claim 1, wherein the first polymer composition comprises a polypropylene composition comprising
A) a grafted polypropylene grafted with C1) a side chain compound capable of forming hydrogen bond and/or
B) a non-grafted polypropylene and C2) a compound capable of forming hydrogen bond, wherein the total amount of A) and B) with respect to the polypropylene composition is at least 70 wt % and
the polypropylene composition comprises D) a low molecular weight polyethylene having molecular weight of at most 5000 g/mol in an amount of less than 10 wt % with respect to the polypropylene composition.

5. The fiber reinforced thermoplastic polymer composition according to claim 1, wherein the second thermoplastic polymer is a polyolefin.

6. The fiber reinforced thermoplastic polymer composition according to claim 1, wherein the amount of the multifilament strand is 10 to 80 wt % with respect to the sheathed continuous multifilament strand and/or wherein the amount of the continuous multifilament strand with respect to the core is at least 99.50 wt %.

7. The fiber reinforced thermoplastic polymer composition according to claim 1, wherein the sheathed continuous multifilament strand comprises a polyethylene wax having a melting point of 50 to 100° C., MW of 5 to 10 kg/mol and a polydispersity index (MWD) of 5 to 10 in an amount of less than 0.50 wt %, with respect to the sheathed continuous multifilament strand.

8. The fiber reinforced thermoplastic polymer composition according to claim 1, wherein the first polymer composition has a melt viscosity in the range from 1.0 to 25 Pas at the melting temperature of the polymer composition, wherein the melting temperature of the polymer composition is determined on a 5 mg sample using a differential scanning calorimetry on the second heating curve using a heating and cooling rate of 10° C./min and wherein the melt viscosity is determined according to ISO6721-10:2015 by applying oscillating-shear to the molten sample at an Angular Frequency of 1 rad/s and shear strain of 5%, preferably wherein the first thermoplastic polymer is a polypropylene.

9. A process for preparing the fiber reinforced thermoplastic polymer composition according to claim 1, comprising the sequential steps of:
a) unwinding from a package of the at least one continuous multifilament strand,
c) applying the second thermoplastic polymer around the at least one continuous multifilament strand to form the sheathed continuous multifilament strand and
optionally d) cutting the sheathed continuous glass multifilament strand into pellets.

10. The fiber reinforced thermoplastic polymer composition according to claim 1, wherein the core comprises an impregnated continuous glass multifilament strand comprising the at least one continuous glass multifilament strand impregnated with an impregnating agent.

11. A process for preparing the fiber reinforced thermoplastic polymer composition according to claim 10, comprising the sequential steps of:
a) unwinding from a package of the at least one continuous multifilament strand,
b) applying an impregnating agent to the at least one continuous multifilament strand,
c) applying the sheath of the thermoplastic polymer composition around the impregnated continuous multifilament strand to form the sheathed continuous multifilament strand and optionally d) cutting the sheathed continuous glass multifilament strand into pellets.

12. A molded article comprising the fiber reinforced thermoplastic polymer composition according to claim 1.

13. The molded article according to claim 12 wherein the molded article is an injection molded article, wherein preferably the article is selected from automotive exterior parts like bumpers and tailgates; automotive interior parts like instrument panels; automotive parts under the bonnet; and parts and housings of air conditioners, dishwashers, washing machines, dryers, coffee machines, power tools (e.g. saws, drills), durable goods (e.g. furniture), 5G antennas, solar panels, bikes and steps.

14. The molded article according to claim 12 wherein the molded article is an extruded and optionally thermoformed article, wherein preferably the article is selected from the group consisting of scaffoldings, battery trays, construction frames and flooring.

15. A process for preparing the molded article according to claim 12 by melt-mixing and molding the fiber reinforced thermoplastic polymer composition and a further polymer, preferably wherein the amount of the multifilament strand is 50 to 80 wt % with respect to the sheathed continuous multifilament strand.
